(19) United States
(12) Patent Application Publication
(10) Pub. No.: US 2001/0032710 A1
(43) Pub. Date: Oct. 25, 2001

(54) Easy-mount sealing element for packaging machines

(76) Inventors: James William Sadler, Toronto (CA); David Campbell King, Bath (CA); David Clifford Riley, Kingston (CA)

Correspondence Address: E I DU PONT DE NEMOURS AND COMPANY, LEGAL DEPARTMENT - PATENTS, 1007 MARKET STREET, WILMINGTON, DE, 19898, US

(21) Appl. No.: 09/758,574

(22) Filed: Jan. 11, 2001

(30) Foreign Application Priority Data
Jan. 11, 2000 (CA) 2295450

(51) Int. Cl. B30B 5/02

(52) U.S. Cl. 156/583.6

(57) ABSTRACT

A heat sealing assembly, for sealing thermoplastic film, comprising first and second jaws, an electrical impulse heat sealing element, electrical terminals, and an electrical and thermal insulating material between the first jaw and the heat sealing element, said heat sealing element being removably connected to said electrical terminals, at least one of said jaws being capable of transverse motion and adapted to collapse a tubular film made from said thermoplastic film and passing between said jaws, wherein said element has at each end an electrical contact male plug oriented at about 90 degrees angle from said element, said plugs being parallel to each other and having a shape which allows each to be received in correspondingly shaped sockets, said sockets being held by spring means adapted to apply force in tension to said element when said plugs are in said sockets, said plugs being adapted to fit into said sockets when said spring means are deflected toward said element, and wherein securing means for preventing arcing between the corresponding plugs and sockets are provided.

### FIELD OF THE INVENTION

The present invention relates generally to film packaging equipment which periodically heat seals two or more films (or film edges) as the film moves through a heat seal station. More specifically, the present invention provides a solution for an arcing problem, between element ends and terminals of an easy-mount heat sealing element. The arcing problem is quite serious since it welds the parts together which is highly problematic since the element needs to be removed for replacement on a regular basis.

### BACKGROUND OF THE INVENTION

Generally speaking, “vertical form, fill and seal” machines are well known and can be used, for example, to package milk in plastic pouches. More recently, such packaging has been used for other flowable materials, such as, mayonnaise, caramel sauce, scrambled eggs, tomato ketchup, chocolate fudge sauce, salad dressings, preserves and the like, particularly for the institutional user market, i.e., restaurants.

In operation, such vertical form, fill and seal machines will generally unroll a flat web of synthetic thermoplastic film and then form the film into a continuous tube by sealing the longitudinal edges with a lap seal or a fin seal. Generally, the tube is then moved downward to a station for filling. A sealing device below the filling station then creates an airtight heat seal across a transverse cross-section of the tube, using a pair of sealing jaws. The material to be packaged will generally enter the tube continuously, although slugs of material may also be used, and therefore the film is generally sealed while some of the material is present between the heat sealing surfaces in the tube.

After the sealing operation has been completed, the jaws are generally opened and the tube is then caused to move down a predetermined distance. Such downward movement may be influenced by the weight of the material in the tube, and/or by a drive mechanism in communication with the tube.

Once the tube moves down a predetermined distance, the heat sealing jaws close once again to create a second transverse seal. Almost simultaneously, the second traverse seal also severs the material-filled portion of the tube, thereby creating a sealed pouch of material. The second transverse sealing operation also simultaneously creates the bottom seal for the next pouch to be formed. One such vertical form, fill and seal machine of the type described above is sold under the trademark PREPAC.

Other conventional vertical form, fill and seal equipment causes the material to be packaged to enter the tube intermittently. In such cases, the material enters the tube only after the jaws have closed to form the first transverse seal. The jaws then open, and the tube is moved downward a predetermined distance. Then, before the second seal is made, the flow of material is stopped, so material will not locate between the heat sealing surfaces in the tube.

In other conventional machine designs, the sealing device does not sever the tube when making the second traverse heat seal, but rather, the tube is subsequently severed at a separate station.

With yet other machines, the heat sealing jaws move with the film as it moves down, and then release the film at a predetermined distance. The jaws then move upward back to their original position to once again engage the film. With such machines, the jaws clamp, seal and sever the tube of film while moving in the downward direction. The jaws then open and disengage from the film and return to their original upward position. The downward movement of the closed jaws also serve to advance the tubular film downward.

The present invention relates to a heat sealing assembly for any of the above mentioned machines.

Conventional sealing elements use short bursts of electrical current to create heat sealing temperatures during only a fraction of the cycle time between operations. The sealing element may be a round wire, e.g. a “piano” wire about 2.00 mm to 2.29 mm diameter, electrically insulated from a temperature controlled supporting jaw. Alternatively, the sealing elements can be rolled from wire stock into a flattened ribbon having a longitudinal bead in the center of one side hereafter referred to as a “solid beaded element”.

Sealing elements having a round wire or solid beaded element are generally combined with conventional flat faced heat sealing jaws, and this design will generally be satisfactory for form and fill machines for packaging milk, water or other highly aqueous products. Other element shapes are generally more satisfactory on form, fill and seal machines when packaging thick flowable materials, such as, mayonnaise, chocolate fudge sauce, scrambled egg mix, dressings, jams and the like. Examples of other conventional sealers are disclosed in U.S. Pat. No. 3,692,613, which issued to R. E. Pederson, U.S. Pat. No. 4,115,182, which issued to M. M. Wildmoser and U.S. Pat. No. 4,744,845 which issued to J. Posey.

Generally speaking, the heat sealing element must be electrically insulated from the metal jaw upon which it is mounted. Furthermore, the heat sealing element is also often thermally insulated from the jaw. Typically, this is accomplished by placing between the jaw and the heat sealing element, a woven glass cloth which is impregnated with polytetrafluoroethylene (PTFE). The heat sealing element must be heated quickly when coming in contact with the film to be sealed.

Various problems with the earlier prior art have been solved, as represented by U.S. Pat. No. 5,538,590—Riley (Jul. 23, 1996) and U.S. Pat. No. 5,415,724—Perrett (May 16, 1995), both of which are incorporated by reference herein.

One additional problem is the difficulty of changing and replacing, as well as removing and re-installing the heat-sealing element and aligning it accurately so the seal is done properly. Changing the element needs to be done regularly, such as daily, in a high-capacity, high speed operation that might be found, for instance, in large dairy operations. The glass cloth impregnated with PTFE such as that sold by DuPont Company as “Teflon”, used over and under the element as in U.S. Pat. No. 5,538,590, is subject to wear and has to be replaced when it is no longer adequately effective. This problem was resolved with the invention of U.S. patent application Ser. No. 09/016,522, filed Jan. 30, 1998, the disclosures of which are incorporated by reference herein.

Finally, there has been found to be an arcing problem in the field that has caused welding of the replacement parts namely between the element ends and terminals of the heat sealing element.

### SUMMARY OF THE INVENTION

The present invention provides a heat sealing assembly, for sealing thermoplastic film, comprising first and second jaws, an electrical impulse heat sealing element, electrical terminals, and an electrical and thermal insulating material between the first jaw and the heat sealing element, said heat sealing element being removably connected to said electrical terminals, at least one of said jaws being capable of transverse motion and adapted to collapse a tubular film made from said thermoplastic film and passing between said jaws, wherein said element has at each end an electrical contact male plug oriented at about 90 degrees angle from said element, said plugs being parallel to each other and having a shape which allows each to be received in correspondingly shaped sockets, said sockets being held by spring means adapted to apply force in tension to said element when said plugs are in said sockets, said plugs being adapted to fit into said sockets when said spring means are deflected toward said element, and wherein securing means for preventing arcing between the corresponding plugs and sockets are provided.

Preferably the securing means comprises a screw which is mounted in the assembly in contact with the plug and socket so that it can tighten the plug in the socket. The socket and plug are preferably provided with an opening, usually drilled there through for receiving the screw or other suitable means from either side of the plug.

This design has resolved the arcing problem noted above which is quite important to enable proper servicing of the machines.

In preferred embodiments, the spring means are flat springs with their broad sides being parallel to each other, each being attached to opposite ends of a temperature stabilized heat sink block, and the opening in each socket is at least a 15° arc to permit increased force on the connections with the plugs and to facilitate cleanability. Alternatively, the jaw may be heat stabilized at about 40° C. using conventional means.

### BRIEF DESCRIPTION OF THE DRAWINGS

FIG. 1 is a plan view of a prior art showing the heat-sealing element in place in the assembly,

FIG. 2 is an elevation of the same subject as FIG. 1,

FIG. 3 is a plan view of a prior art,

FIG. 4 is an elevation of the same subject as FIG. 3,

FIG. 5 is an elevation of a heat-sealing element of the prior art separated from the assembly,

FIG. 6 is a side view of a flat spring preferred for use with the prior art element,

FIG. 7 is a front view of the same subject as FIG. 6,

FIG. 8 is a perspective view of a currently commercial heat-sealing assembly, and

FIG. 9 is a side view of the device of the present invention.

### DETAILED DESCRIPTION OF THE PREFERRED EMBODIMENTS

A current commercial design of horizontal sealing bar or jaw 1 is shown in FIG. 8. It uses an impulse sealing cycle, i.e. there is a burst of sealing energy lasting about 220 milliseconds when the jaws are closed. The filler makes a pouch every time the jaws close which is about once every second. Heating element 2 is preferably made from 17 AWG “Chromel” C electrical resistance wire rolled to a special shape to promote sealing and cutting all in one closing action of the jaw. Chromel C is the trademark of Hoskins Manufacturing Co. Another useful wire is “Tophet” Alloy C made by Carpenter Technology Corp. These are preferably nickle-chromium electrical resistance wires conforming to ASTM B-344. The active length of the element is preferably about 200 mm. The heating element can operate as high as 300° C. and this causes substantial thermal expansion. This thermal expansion is taken up by springs 8 which are tensioned when the element is fastened in place by end binding posts 7. The heating element is electrically and thermally insulated from the aluminum sealing bar by two layers of preferably PTFE coated glass fibre cloth. The material for the insulating layer could also be selected from glass fibre containing PTFE infusion or from glass-epoxy material. It may be in the form of self-adhering tape. Another layer of coated glass fibre cloth 5 is placed over the surface of the element to help hold it in place and to act as a release sheet when making the heat seal. The cloth is frequently in the form of an adhesive tape. Although PTFE is an excellent release agent, it is fairly soft and will wear through in this service. Thus it becomes necessary for the filler operator to periodically replace both the upper and lower layers of tape. This is a job that requires some skill for the operator must get the heating element properly aligned and flat against the sealing bar, the right amount of tension in the springs and the tapes properly applied. Improper servicing of the jaw will likely result in leaking seals. The hardest thing to do is to get the element flat against sealing bar 4 and this is most critical. An improperly aligned element will very quickly develop a hot spot which will cause premature failure of the PTFE coated glass fibre tape which will result in sealing problems. This type of servicing of the sealing jaw must be done at least once per day on a dairy filler, and many filler operators find it difficult, particularly new operators. Ports 9 are provided in jaw 1 for heat transfer fluid.

The improvements to the sealing jaw described are an attempt to make servicing the sealing jaw easier and less prone to improper setup and thus reduce the potential for “leakers.”

In arriving at this solution for the arcing problem, many approaches were tried, most based on ensuring that the original device as described in U.S. patent application Ser. No. 09/016,522 was put into practice. For example:

1. element ends were scribed properly as the ends were inserted into the terminals, removing the insulating oxide coating;

2. elements were under appropriate tension as the ends were inserted into the terminals;

3. element ends were fabricated within the tolerances of the design;

4. terminals were fabricated within the tolerances of the design;

5. elements were removed daily during CIP (clean-in-place) to study if CIP chemicals were causing oxydation; and

6. terminals with larger and smaller bores were also trialled.

All the above failed to pinpoint the problem and arcing continued.

Finally, the terminal was drilled and tapped on each side, and a thumbscrew was mounted in one of the tapped holes (the one on top). The operator was requested to loosen the thumbscrew on each terminal before removing the element from the jaw, and tighten the thumbscrew after the element was installed.

During operation, the effect of having the tight thumbscrew is to ensure good electrical contact is made between the element ends and the terminals. This contact is made in two ways:

1. the outside of the element end is pushed against the bore of the terminal, causing good contact; and

2. there is good contact between the terminal and the thumbscrew, and between the thumbscrew and the element and, since the thumbscrew is pushing against the element end at the thumbscrew's end, and is being pushed by the threads in the terminal.

This new design prevents arcing between the element ends and the terminal. In addition, the securing means ensures good electrical contact and eliminates the necessity of ensuring critical tolerances between the mating parts.

### APPARATUS OF THE INVENTION

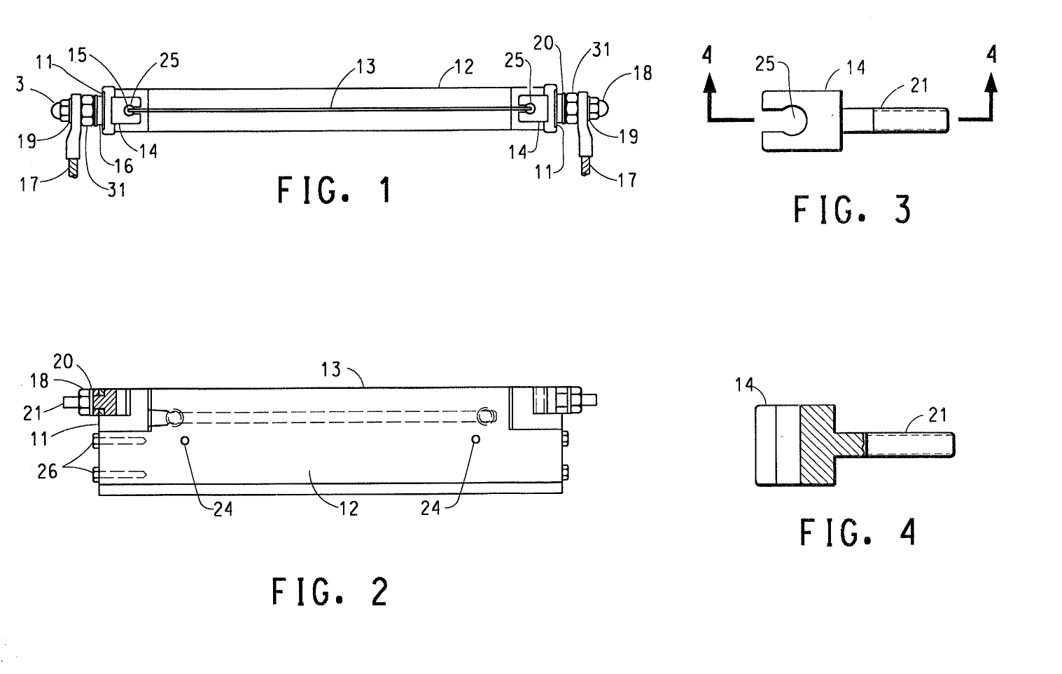

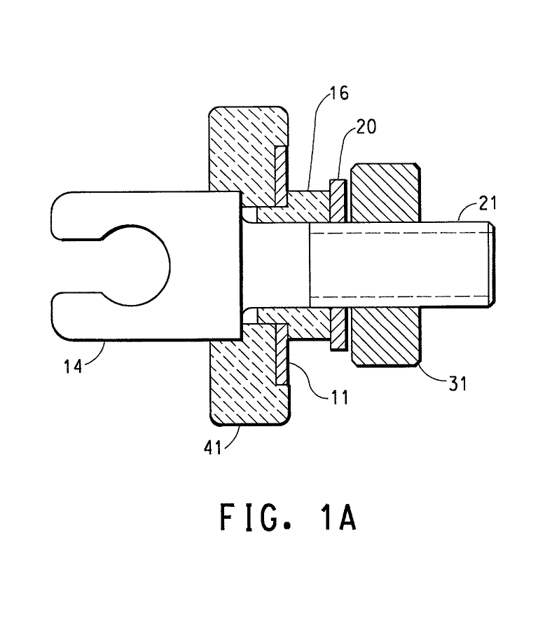

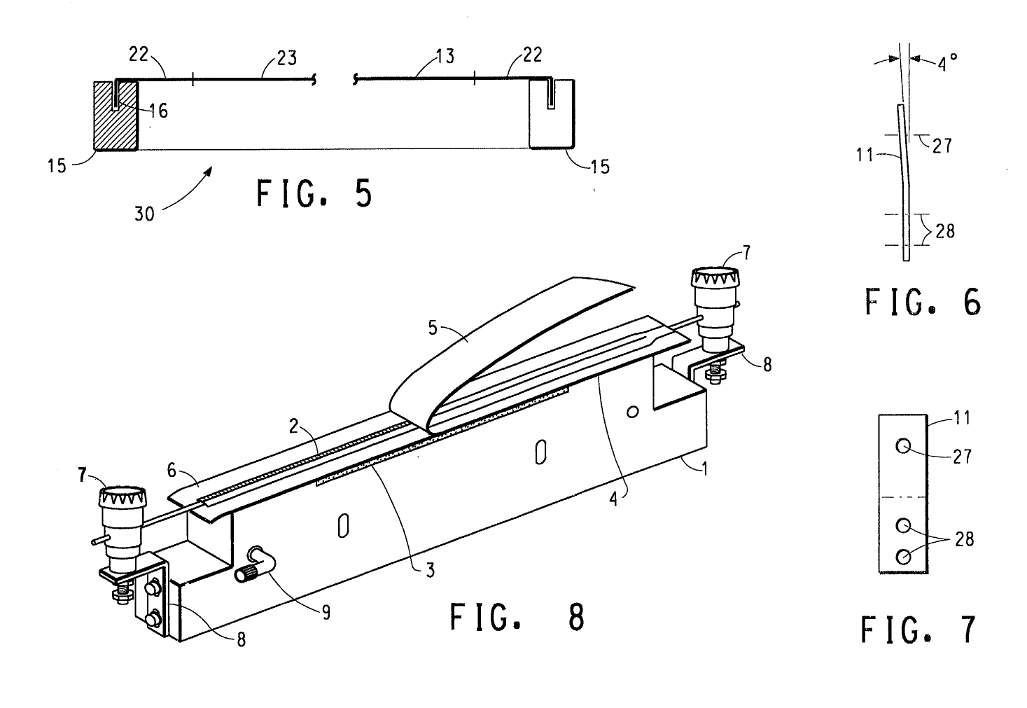

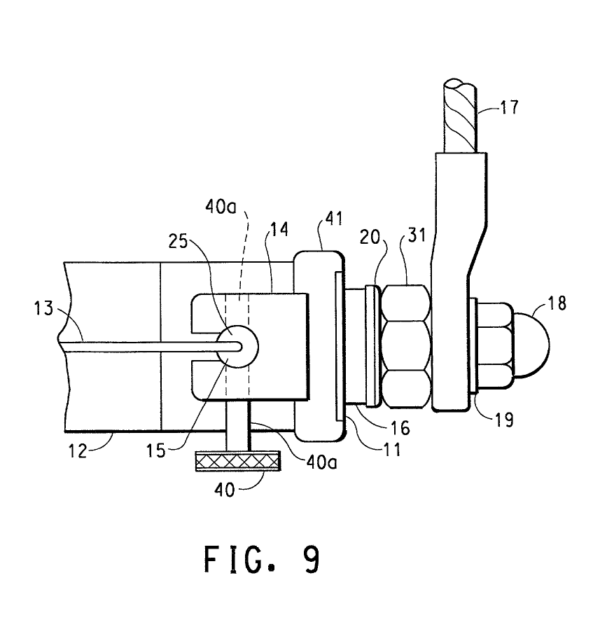

The prior art apparatus is shown in FIGS. 1 and 2, with the parts in FIGS. 3-7. This is a direct replacement for jaw 1 shown in FIG. 8 (prior art also) and in fact can use the same basic parts of sealing bar or jaw 1 and 12. L-shaped end springs 8 have been replaced by short cantilever leaf springs 11 to which have been attached preferably stainless steel (brass may be used in which case, the element plug 15 is made of copper) sockets 14. Each socket 14 element contains a through slot 25, which may be in the shape of a keyhole. Slot shapes need not include transverse oepnings. The heating elements 13 have generally cylindrical plugs 15 on the ends that are sized and shaped to fit snugly into the slots 25 at about right angles to wire (heat element) 13. Springs 11 are bent slightly outwards so that it is necessary to bend (deflect) them together in order for cylindrical plugs 15 to fit into slots 25. The total spring deflection (both springs) amounts to about 3 mm. This is sufficient to accommodate the thermal expansion of the element during a heating cycle and still maintain tension in the element. The socket 14 is held in place and electrically isolated from the spring 11 (and the rest of the jaw 12) by a grooved insulator piece 41 which fits around the spring 11, a flanged insulator bushing 16, and locating hole 27 in the spring 11. The socket has threaded stud 21 which passes through insulating pieces 41 and 16 and actually passes through a hole in bushing 16, which passes its smaller diameter through the hole 27 in the spring 11. Insulating pieces 41 and 16 are held together by flat washer 20 and hexagonal nut 31. Then, heavy electrical cable 17 which supplies the power to the jaw is fastened to this stud 21 by lock washer 19, optional flat washer 20, and cap nut 18. As in the current design, the active length of the element may optionally be electrically isolated from the sealing bar by two layers of PTFE coated glass fibre tape under the element with another layer over the top to act as a release sheet, similar to 5 and 6 in FIG. 8.

In the prior art device described in U.S. patent application Ser. No. 09/016,522, the design of slot 25 is said to be quite important. For sealing jaw 12 described, one needs a current of about 40 amps during the impulse heating cycle to generate the necessary temperature to make a heat seal and sever the pouches. This requires a fairly robust electrical connector. Good electrical connector design requires a high force between connector parts to keep the contact resistance low and avoid heating. However, because of the thinness of the heating element wire and the difficulty of handling it, one cannot exert a large force to insert or remove the plug in the socket without risk of bending or damaging the wire. This problem was overcome by making the width of slot 25 in socket 14 nearly the width of plug 15. The short leaf springs are fairly stiff and require a good force (bending moment) to deflect them. Once plug 15 has been inserted into socket 14 and spring 11 has been released, the full spring force comes to bear against the bearing or projected area of socket 14 which was reduced by making slot 25 wide. The resulting stress between plug 15 and socket 14 is thus high, just what is needed for low contact resistance. But slot 25 is not so wide that plug 15 actually jams in slot 25. Thus plug 15 can be easily inserted or removed from socket 14 without excessive force by simply bending (deflecting) spring 11 to take the force off plug 15. The high stress between plug 15 and socket 14 effectively causes the oxidation on the surfaces to be scraped off as plug 15 is pushed down into socket 14.

In the device of the present invention, the above design aspects relating to the plug and socket are no longer critical because the securing means ensures electrical contact.

There is a classical problem with electric heater design at the ends of the heating element. Because of the inherent electrical resistivity of the heating element wire, heat will be generated right to the end of the wire. But somehow one must eventually connect the resistance wire to a lower resistance conductor and deal with the heat. The best low resistance and almost universally used conductors are copper or a copper alloy but these do not tolerate high temperatures well. Generally electrical connections should be kept relatively cool to avoid oxidation of the surfaces and high contact resistance. Once an electrical connection starts to deteriorate, it can become worse quickly. A poor connection generates heat which in turn causes further oxidation and deterioration of the connection which in turn generates even more heat. In this design the problem is overcome by plating the ends 22 of the element wire with copper or silver. The plating, if thick enough, effectively eliminates the resistance of the wire near the plug and socket connection and thus keeps it relatively cool. The plating needs to cover the length of element wire 22 between the end plug and sealing bar 12. It is also desirable that the plating be even longer so that it continues onto the active face of sealing bar 12 for a short distance. The reason for this is that sealing bar 12 is water cooled or temperature stabilized and operates at or near ambient temperature. Thus the length of plated element 22 overlapping sealing bar 12 provides a path for the heat to escape from the end of the unplated or hot part 23 of the element wire and reduce connector heating by thermal conduction down the wire.

Although copper and silver plating work well, coating the element wire with silver solder is another good way to reduce the electrical resistance or heating on the ends. Silver solder tolerates the high temperatures well. However, due to its higher electrical resistivity, a thicker coating is required than for copper or silver.

Superimposed on all the other design issues is the sanitary requirement that the main assembly be readily cleanable. The horizontal jaw on a vertical form, fill, seal filler is right under the nozzle of the fill tube. Any filler problems which allow the escape of the product will likely mean that the product will spill over the horizontal jaw. In a dairy, this situation is usually cleaned up with a spray of hot water. At the end of a production day, the filler is again cleaned with hot water and cleaning and sanitizing solutions. There must be no pockets to trap milk, water or cleaning chemicals. The preferred material of construction in a dairy filler is 300 series stainless steel and certain approved plastics. Exposed threaded fasteners are undesirable. An examination of the apparatus of this invention will show that the design is readily cleanable and that stainless steel or brass may be used for the socket 14, and leaf springs 11 and fasteners 18, 19, 20, 21 and 31 (fasteners may be brass) and insulators 15 and 16 are made from resin, such as glass reinforced epoxy laminates. The threads on the fasteners 18, 21 and 31 are all physically covered. Brass or copper has been deemed acceptable for the element plugs 15 because the elements are removed for servicing. The elements also have a finite life of several days so that any deterioration of the brass or copper surface over time is not a concern. There are few high capacity, commercial electrical connectors which meet sanitary requirements.

The main feature of the prior art apparatus is the ease of installing elements correctly. To install the element in the jaw, the operator inserts a plug 15 in one slotted socket 14 and then, while bending (deflecting)the spring 11 on the opposite end, inserts the remaining plug 15 in its socket 14. There is no force applied to the element so that it is not distorted in any way. Once the plugs 15 are in the sockets 14, the operator then pushes them “home” until the element lies flat against the active face of the sealing bar 12. There isn't the “fiddling” and “adjusting” as required with the current design to get the element down flat against the sealing bar 12.

Referring now to FIG. 9 which illustrates the present invention, there is shown one end of a jaw assembly apparatus as shown in FIGS. 1 and 2 which incorporates securing means which precludes arcing of the jaw assembly once positioned in a filler apparatus. The securing means preferably comprises a thumbscrew 40 which is tightly secured into an opening 40a which extends through socket 14 thereby allowing the thumbscrew 40 to press against cylindrical plug 15 and hence to make secure electrical contact in keyhole slot 25 between cylindrical plug 15 and slot 25. In a preferred form of the invention, opening 40a is drilled completely through socket 14. The presence of the thumbscrew ensures good electrical contact between the plug 15 and socket 25 eliminating arcing between these parts.

1. A heat sealing assembly, for sealing thermoplastic film, comprising first and second jaws, an electrical impulse heat sealing element, electrical terminals, and an electrical and thermal insulating material between the first jaw and the heat sealing element, said heat sealing element being removably connected to said electrical terminals, at least one of said jaws being capable of transverse motion and adapted to collapse a tubular film made from said thermoplastic film and passing between said jaws, wherein said element has at each end an electrical contact male plug oriented at about 90 degrees angle from said element, said plugs being parallel to each other and having a shape which allows each to be received in correspondingly shaped sockets, said sockets being held by spring means adapted to apply force in tension to said element when said plugs are in said sockets, said plugs being adapted to fit into said sockets when said spring means are deflected toward said element, and wherein securing means for preventing arcing between the corresponding plugs and sockets are provided.

2. The heat seal assembly as claimed in claim 1 wherein the securing means comprises a screw which is mounted in the assembly in contact with the plug and socket so that it can tighten the plug in the socket.

3. The heat seal assembly as claimed in claim 2 wherein there is provided an opening in the plug and socket for receiving the screw from either side of the socket.
